(19) United States
(12) Patent Application Publication
(10) Pub. No.: US 2026/0278948 A1
(43) Pub. Date: Sep. 17, 2026

(54) RADIO FREQUENCY SIGNAL LOCATION SENSING ASSISTED MAP GENERATION

(71) Applicant: QUALCOMM Incorporated, San Diego, CA (US)

(72) Inventors: Akansh JAIN, Chennai (IN); Pawan Kumar BAHETI, San Diego, CA (US); Sebastien MOUNIER, San Diego, CA (US); G SRIRAM, Karaikudi (IN); Xiaoxin ZHANG, Sunnyvale, CA (US); Simone MERLIN, San Diego, CA (US); Peerapol TINNAKORNSRISUPHAP, San Diego, CA (US); Andres Oscar ALTIERI, Bures-sur-Yvette (FR); Tom Edward BOTTERILL, San Diego, CA (US)

(21) Appl. No.: 19/078,140

(22) Filed: Mar. 12, 2025

(51) Int. Cl. G06T 19/00; G01S 13/76; G06F 3/01

(52) U.S. Cl. CPC G06T 19/006; G01S 13/765; G06F 3/011

(57) ABSTRACT

Systems and techniques are described herein for rendering an extended reality (XR) environment. For example, a computing device can generate, based on a received radio frequency (RF) signal, a local map representing an area in which a first device is located; align features of the local map with features of a reference map associated with a predetermined location; determine, based on the aligned features, the first device is located at the predetermined location; and render, a virtual representation of the aligned local map and the aligned reference map at the predetermined location.

### FIELD

The present disclosure generally relates to using radio frequency (RF) signals for location sensing to assist in map generation of an environment. For example, aspects of the present disclosure relate to systems and techniques for RF signal location sensing assisted map generation.

### BACKGROUND

Extended reality (XR) technologies can be used to immerse users within an XR environment. The term XR can encompass virtual reality (VR), augmented reality (AR), mixed reality (MR), and the like. XR systems can be included in a head-mounted device (HMD). An XR environment can be a three-dimensional (3D) representation of a real-world environment which can include virtual content, virtual objects, etc. added to the 3D representation. HMDs can include a display allowing a user to view a real-world environment through the display. For example, the HMD can include a scene-facing camera to generate images of the real-world environment. XR technologies can use map generation techniques to generate three-dimensional representations of the environment, which can be rendered by the HMD to be displayed to a user.

Devices using XR technologies (referred to as XR devices) generally rely on location tracking of the user in real-time to render XR environments (e.g., to place virtual objects in consistent positions) from the perspective of the user. In some examples, the XR devices can use inertial measurement units (IMU) and cameras to track user movement within an environment to determine how to render and display the XR environment to the user. Current location sensing techniques for positioning of virtual content within XR environments can suffer from accuracy issues in environments lacking distinct visual features (e.g., a plain room), dark conditions (e.g., low light settings), overexposed conditions (e.g., a bright environment), etc. Current location sensing techniques can also require high power consumption when performing location sensing by processing images and can introduce latency causing a delay in rendering of virtual content when a user moves in the XR environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for rendering an extended reality (XR) environment is provided. The apparatus includes at least one memory and at least one processor coupled to the at least one memory and configured to: generate, based on a received radio frequency (RF) signal, a local map representing an area in which a first device is located; align features of the local map with features of a reference map associated with a predetermined location; determine, based on the aligned features, the first device is located at the predetermined location; and render a virtual representation of the aligned local map and the aligned reference map at the predetermined location.

In some aspects, an apparatus for rendering an extended reality (XR) environment is provided. The apparatus includes at least one memory and at least one processor coupled to the at least one memory and configured to: determine, based on one or more radio frequency (RF) signals, a location of an object within a predetermined distance from an extended reality (XR) device; determine, using an inertial measurement unit, an orientation of the XR device associated with when the XR device received the one or more RF signals; and generate a map based on the one or more RF signals and the orientation of the XR device, wherein the map includes the object.

In some aspects, a method for rendering an extended reality (XR) environment provided. The method includes: generating, based on a received radio frequency (RF) signal, a local map representing an area in which a first device is located; aligning features of the local map with features of a reference map associated with a predetermined location; determining, based on the aligned features, the first device is located at the predetermined location; and rendering a virtual representation of the aligned local map and the aligned reference map at the predetermined location.

In some aspects, a method for rendering an extended reality (XR) environment provided. The method includes: determining, based on one or more radio frequency (RF) signals, a location of an object within a predetermined distance from an extended reality (XR) device; determining, using an inertial measurement unit, an orientation of the XR device associated with when the XR device received the one or more RF signals; and generating a map based on the one or more RF signals and the orientation of the XR device, wherein the map includes the object.

In some aspects, a non-transitory computer-readable medium is provided having stored thereon instructions that, when executed by at least one processor, cause the at least one processor to: generate, based on a received radio frequency (RF) signal, a local map representing an area in which a first device is located; align features of the local map with features of a reference map associated with a predetermined location; determine, based on the aligned features, the first device is located at the predetermined location; and render a virtual representation of the aligned local map and the aligned reference map at the predetermined location.

In some aspects, a non-transitory computer-readable medium is provided having stored thereon instructions that, when executed by at least one processor, cause the at least one processor to: determine, based on one or more radio frequency (RF) signals, a location of an object within a predetermined distance from an extended reality (XR) device; determine, using an inertial measurement unit, an orientation of the XR device associated with when the XR device received the one or more RF signals; and generate a map based on the one or more RF signals and the orientation of the XR device, wherein the map includes the object.

In some aspects, an apparatus for rendering an extended reality (XR) environment is provided. The apparatus includes: means for generating, based on a received radio frequency (RF) signal, a local map representing an area in which a first device is located; means for aligning features of the local map with features of a reference map associated with a predetermined location; means for determining, based on the aligned features, the first device is located at the predetermined location; and means for rendering a virtual representation of the aligned local map and the aligned reference map at the predetermined location.

In some aspects, an apparatus for rendering an extended reality (XR) environment is provided. The apparatus includes: means for determining, based on one or more radio frequency (RF) signals, a location of an object within a predetermined distance from an extended reality (XR) device; means for determining, using an inertial measurement unit, an orientation of the XR device associated with when the XR device received the one or more RF signals; and means for generating a map based on the one or more RF signals and the orientation of the XR device, wherein the map includes the object.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with aspects of the present disclosure.

FIG. 2 is a block diagram illustrating an example process of aligning local maps and reference maps to determine position and orientation of an XR device, in accordance with aspects of the present disclosure.

FIG. 3 is a block diagram illustrating an example of a data fusion pipeline, in accordance with aspects of the present disclosure.

FIG. 4 is a block diagram illustrating example RF sensing techniques, in accordance with aspects of the present disclosure.

FIG. 5 is an example XR device using visual detection and RF sensing to detect objects in an environment, in accordance with aspects of the present disclosure.

FIG. 6 is a flowchart diagram illustrating an example of a process of detecting objects within proximity of an XR device, in accordance with aspects of the present disclosure.

FIG. 7 is a flowchart diagram illustrating an example process of rendering an XR environment, in accordance with aspects of the present disclosure.

FIG. 8 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, extended reality (XR) technologies can be used to immerse users within an XR environment. The term XR can encompass virtual reality (VR), augmented reality (AR), mixed reality (MR), and the like. XR systems can be included in a head-mounted device (HMD), such as an extended reality (XR) head mounted device. An XR environment can be a three-dimensional (3D) representation of a real-world environment which can include virtual content, virtual objects, etc. added to the 3D representation. HMDs can include a display allowing a user to view a real-world environment through the display. For example, the HMD can include a scene-facing camera to generate images of the real-world environment. XR technologies can use map generation techniques to generate three-dimensional representations of the environment, which can be rendered by the HMD to be displayed to a user.

As further noted, devices using XR technologies (referred to as XR devices) generally rely on location tracking of the user in real-time to render XR environments (e.g., to place virtual objects in consistent positions) from the perspective of the user. In some examples, the XR devices can use inertial measurement units (IMU) and cameras to track user movement within an environment to determine how to render the XR environment to be displayed to the user. Current techniques of location sensing of XR devices for visual positioning of virtual content within XR environments can suffer from accuracy issues in environments lacking distinct visual features (e.g., a plain room), dark conditions (e.g., low light settings), overexposed conditions (e.g., a bright environment), etc. Current techniques of location sensing of XR devices can also require high power consumption when using image processing techniques and can have high latency causing a delay in rendering of virtual content when a user moves position in the XR environment.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. For example, AR content can include adding a heads-up display (HUD) providing informational virtual content to users regarding their environment. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment (e.g., an AR environment, VR environment, and/or MR environment) can be interacted with in a seemingly real or physical way. For example, as a user experiencing an AR environment (e.g., an augmented version of a real-world environment) moves in the real world, rendered virtual content (e.g., images rendered in a virtual environment or XR environment during an AR experience) also changes, giving the user the perception that the user is moving within the AR environment. For example, a user can turn left or right, look up or down, and/or move forwards or backwards, thus changing the user's point of view of the AR environment. The AR content presented to the user can change accordingly, so that the user's experience in the AR environment is as seamless as it would be in the real world. Similar experiences can be presented in VR and/or MR environments.

In some examples, the XR device can include one or more optical sensors (e.g., cameras). In such an example, the XR device can include one or more scene-facing optical sensors and ranging sensors (e.g., multiple cameras, light detection and ranging (LIDAR) sensors, etc.) and eye-facing camera. In some examples, the XR device can generate visual representations of the environment from the scene-facing optical sensors and a user view of the visual representation based on the eye-facing camera. In one example, a display of an optical see-through XR device can include a lens or glass in front of each eye (or a single lens or glass over both eyes). The see-through display can allow the user to see a real-world or physical object directly, and can display (e.g., projected or otherwise displayed) an enhanced image of that object or additional AR content (e.g., virtual content overlaid on a visual representation of the environment) to augment the user's visual perception of the real world.

In some cases, an XR system can match the relative pose and movement of objects and devices in the physical world. For example, the XR system can use tracking information to calculate the relative pose of devices, persons, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment (e.g., an extended reality environment). In some cases, an XR system can track parts of the user (e.g., a hand and/or fingertips of a user) to allow the user to interact with virtual objects and a mesh representation of the real-world environment.

XR systems or devices can facilitate interaction with different types of XR environments (e.g., a user can use an XR system or device to interact with an XR environment). One example of an XR environment (e.g., extended reality environment) is a virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users. XR environments can include a combination of visual characteristics from visual representations of virtual environments and real-world environments (e.g., visual representations of the real-world environments). For example, XR environments can include virtual content rendered in a representation of the real-world environment modifying the visual representation of the real-world environment such as by adding virtual objects not physically present in the real-world environment or modifying the appearance of physical objects represented in the XR environment.

Reference maps can include 3D spatial representations of a real-world environment which XR devices (and XR systems) can use to track the position of the XR device within the real-world environment. Reference maps can be used to provide spatial understanding an environment to assist in placing virtual content consistently in an XR environment. For example, reference maps can be used to determine where virtual content should be placed and rendered (e.g., displayed to the user in the XR environment) when displayed to a user to allow for consistent rendering of the virtual content in a location (e.g., allowing for virtual content to be rendered at a location consistently when the user moves throughout the real world environment).

For example, many XR environments include virtual content to augment the environment viewed by the user. When the user moves through the environment, some examples of virtual content should remain viewable at a fixed location within the environment (e.g., virtual content augmenting a 3D representation of a wall such as by adding a painting, changing the color of the wall, etc.). In such an example, movements of virtual content may disorient the user or cause inconsistent rendering of XR environment such as by moving the location of virtual content.

XR devices can use reference maps and location sensing of the user to assist in consistent placement of virtual content as users move through the environment. In some examples, generating reference maps can be a computationally intensive operation. For example, XR devices can use various image processing techniques to generate 3D representations of the environment (e.g., the reference map). For example, XR devices can use techniques such as mesh generation using geometric estimations of an environment to generate a 3D representation of the environment as vertices, edges, and faces of polygons within the environment. In another example, the reference maps can be represented as voxels. For example, XR devices can include scene-facing cameras and ranging sensors. In such an example, the XR devices can generate images including spatial data (e.g., ranging data from the ranging sensors such as light detection and ranging (LIDAR) sensors). The XR devices can represent the images and spatial data as a voxel. In another example, the XR device can use spatial data to generate reference maps as a 3D point cloud representation of the environment.

In some examples, reference maps can be pre-generated for an environment and used for multiple instances of rendering XR environments for a location. As previously noted, reference map generation can be a computationally intensive operation. Computational resources can be conserved by generating a reference map for an environment and reusing the reference map when rendering an XR representation of the environment for subsequent instances of user XR experiences in the environment. For example, XR devices can store reference maps in memory, or in a database of reference maps. When the XR devices are used at a location or environment which already has a pre-generated (e.g., generated for a prior instance providing an XR environment for the location) reference map, the XR device can use the pre-generated reference map to conserve computational resources by reducing duplicative operations of generating a reference map of an environment which had been previously generated.

Location sensing can be used with the reference maps to determine where an XR device is within the environment represented by the reference maps. Location sensing, including position and orientation of the user, can allow the XR device to render the XR environment consistently and accurately by providing that fixed virtual objects are positioned consistently within the XR environment and that the view of the XR environment viewed by the user is consistent with the position and location of the user in the real-world environment.

RF signals can be used for location sensing and to generate map representations of an environment. For example, XR devices can be configured to output (e.g., transmit) RF signals and receive RF signals. For example, the XR devices can output RF signals such as Wi-Fi, Ultra-Wide Band (UWB), Bluetooth, millimeter wave (mmWave) signals, etc. In some examples, the XR devices can determine location of a user (e.g., the user using the XR device) within an environment based on reflections of the output RF signals. In further examples, the XR device can determine location of a user based on communications with another device. For example, the XR device can determine location based on communications with an access point (AP), such as a Wi-Fi router, another XR device, internet of things (IoT) device, etc.

Systems, apparatuses, electronic devices, methods (also referred to as processes), and computer-readable media (collectively referred to herein as “systems and techniques”) are described herein for rendering an XR environment. In some aspects, the systems and techniques can include determining a location of the XR device using RF signals (e.g., RF signals transmitted by the XR device or another device) and determining a reference map to use to generate an XR environment.

In some aspects, the systems and techniques can include generating a reference map associated with a real-world environment. For example, the reference map can be a 3D representation of the real-world environment. In some examples, the reference map can be a 3D point cloud, a mesh representation, a voxel, or other 3D representation of the real-world environment. In some examples, an XR device can generate the reference map using one or more scene-facing cameras. In another example, the XR device can use stereo vision techniques to generate a 3D representation of the real-world environment.

In some aspects, the systems and techniques can include using RF signals to detect various RF transmitting devices within the real-world environment. RF transmitting devices can be devices configured to communicate with other devices (e.g., an XR device) using RF signals (e.g., Wi-Fi, Bluetooth, UWB, etc.). For example, RF transmitting devices can include smartphones, access points (APs), Bluetooth devices, IoT devices, etc. In some aspects, the systems and techniques can include using RF signal transmitted by the XR device or by other RF transmitting devices, to determine a location of the XR device. In some examples, the determined location of the XR device can be an absolute location. For example, when the location of the RF transmitting devices is known, the location of the XR device can be determined based on communications between the XR device and the RF transmitting devices. For example, various triangulation techniques can be used to determine the location of the XR device based transmitted RF signals between two or more RF transmitting devices and the XR device.

In some aspects, the systems and techniques can include using channel state information (CSI) of RF signals to determine location of the XR device and to determine characteristics (e.g., features) of the environment in which the XR device is located. For example, CSI can include information associated with RF signals such as attenuation, phase shifts, signal strength, fading, multipath effects (distortions in RF signals such as scattering), etc. In some examples, such as when an object in the environment is in motion, the XR device is in motion, etc., CSI can include doppler effects (e.g., changes in frequency of the RF signals observed during motion).

In some aspects, the systems and techniques can include storing the reference map in memory. For example, the systems and techniques can include storing the reference map in a database, repository, cloud storage, etc. In further examples, the systems and techniques can include storing the reference map in local memory of the XR device. In some aspects, the XR device can associated the reference map with a location in the real-world environment. For example, the reference map can include metadata, annotations, labels, etc. indicating a location (or area) in the real-world environment associated with the reference map. For example, the location can be a room of a building.

In such an example, additional XR devices (or the XR device which generated the reference map) can conserve computational resources by receiving the reference map when at the location associated with the reference map (e.g., within an area of the real-world environment associated with the reference map). For example, receiving the reference map can include requesting (e.g., querying) a server, database, repository, etc. to transmit the reference map to the additional XR device. In further examples, the reference map can be stored in memory of the XR device (or additional XR devices) and receiving the reference map can include using the reference map stored in memory of the XR device.

In some aspects, the XR device can use a local map to determine a position and orientation of the XR device within an environment. The local map can be a 3D representation of a portion of the real-world environment (e.g., a mesh, voxels, 3D point cloud, etc.). In some aspects, the systems and techniques can include aligning the local map with a reference map to determine the location and orientation of the XR device within an environment. For example, the local map can be a coarse map (e.g., lower resolution or partial representation) representation of the reference map. In such an example, the XR device can determine where the user is located and oriented (e.g., where the user is facing or looking) based on the features of the local map aligning with features of the reference map.

For example, the local map may indicate that a table is in front of the user and a wall is behind the user. The systems and techniques can include determining a location within the environment represented in the reference where the user is located based on alignments in features of the local map and the reference map. In such an example, the XR device using the local map can conserve computational resources by generating a 3D representation of a portion of the environment (e.g., the local map) which can be smaller and lower resolution than the reference map.

In some aspects, the systems and techniques can include rendering (e.g., generating) an XR environment representing the real-world environment. For example, the XR environment can include virtual objects added to the representation of the real-world environment. In further examples, the XR environment can include adjustments to the representations of real-world objects represented in the XR environment. In such an example, an object in the real-world environment can include adjustments in appearance such as applying virtual content (e.g., a virtual skin, change in color, etc.) to the object to change the appearance of the object when viewed in the XR environment.

In some examples, the XR device can determine the location of a user of the XR device based on communications between the XR device and another device (e.g., an RF transmitting device). The systems and techniques can include various RF sensing techniques for determining the location of an XR device within a real-world environment. In some aspects, the systems and techniques can include using an XR device including a transmitter and receiver co-located at the XR device. In such an example, the RF sensing techniques can include monostatic sensing. Monostatic sensing can include using the RF signals to detect various objects within the real-world environment. For example, the XR device can output an RF signal and determine based on an angle of arrival of a reflected RF signal (e.g., the RF signal output by the XR device reflected from an object in the real-world environment). For example, the XR device can determine, based on an angle at which the XR device receives the reflected RF signal (e.g., the angle of arrival (AoA)), an orientation of the XR device compared to an object in the real-world environment. For example, the XR device can determine based on the angle of arrival of reflected RF signals, whether an object is orthogonal to the orientation of the XR device or at an angle.

In some aspects, the XR device can determine a distance of an object from the XR device based on a round trip time (RTT) of a transmitted RF signal. For example, the RTT can be an amount of time for the XR device to receive the RF signal reflected from an object in the environment. In such an example, the XR device can determine distance based on the amount of time to receive the reflected RF signal. For example, the RF signal can travel at a substantially constant speed through a medium such as air. RF signals, as part of the electromagnetic spectrum, travel at the speed of light, which through air can be approximately 2.997×10⁸ meters per second. In some aspects, the XR device can determine the distance of objects from the XR device based on the RTT multiplied by an expected speed of the RF signal.

In one example, the real-world environment can be an office building with multiple RF transmitting devices. In such an example, the XR device can use bistatic sensing to determine location of a user (e.g., the user using the XR device which can include the location of the XR device). Bistatic sensing can include using another two or more devices to determine a location of the devices. For example, the XR device can transmit RF signals to another device, such as an RF transmitting device. In such an example, the XR device can be a transmitter, and the other device can be a receiver at a different location from the XR device. The XR device and the other device can transmit RF signals, and based on the RTT and AoA, can determine the location of each other in relation to each other (e.g., XR device is ten meters away at a 45 degree angle). In some examples RF transmitting devices can be associated with an absolute location within the real-world environment. For example, an AP can be mounted at a location within the real-world environment. In such an example, the absolute location of the XR device can be determined based on the distance of the XR device from the AP.

In some aspects, the XR device can use RF signals and cameras to determine location of the XR device. For example, the XR device can use the RF signals and one or more image sensors (e.g., cameras) to generate a local map representation of the real-world environment. In such an example, the XR device can use image processing techniques, such as using stereo vision, to generate an additional local map or to supplement the local map generated using RF signals (e.g., to increase resolution or add additional detail to the local map). In such an example, the systems and techniques can align the local map with a reference map (e.g., by aligning features of the local map with features of the reference map) to determine the location and orientation of the XR device (or user using the XR device). In some examples, the same device which generated the reference map can generate the local map. For example, the local map and the reference map associated with a location can be generated using the same XR device.

In some aspects, the XR device can provide continuous (or near-continuous) transmission of RF signals to detect objects within vicinity of the user. For example, the XR device can generate an XR environment representation of a real-world environment using the reference map. In such an example, the XR device can be or include an HMD, and can display the XR environment to a user by a display of the HMD. The XR device can use RF signals to track movements of objects in the real-world environment. In such an example, the XR device can update the XR environment based on movements of the objects.

For example, the XR device can use radio detection and ranging (RADAR) to determine the objects and object motion within the real-world environment. For example, the XR device can use RF signals including RADAR to track movements of objects in the real-world environment. In some examples, the XR device can be part of an XR system including additional other devices associated with providing an XR environment to the user. For example, the XR system can include an XR device such as an XR HMD and a wearable device providing additional feedback to a user. For example, the wearable device can be a haptic vest used to provide haptic feedback to a torso of the user. In such an example, the wearable device can vibrate to simulate various conditions in an XR environment, such as to simulate wind blowing against the body of the user, to simulate being tapped on the shoulder, etc.

Another example of a wearable device can include haptic device to be worn on the hands or feet of the user. In such an example, the haptic device can be used to simulate conditions such walking on sand, feeling different textures, etc. The XR device can use bistatic sensing to determine the location of the wearable devices and the XR device. In such an example, the wearable devices and the XR device can output RF signals and determine, based on reflected RF signals or RF signals from an RF transmitting device, the location (such as position and orientation) of the XR device and the wearable devices. In some examples, the wearable devices and the XR device can determine position and orientation individually (e.g., the XR device can determine a position and orientation associated with the XR device, the wearable device can determine a position and orientation associated with the XR device, etc.). In further examples, the XR device can determine the position and orientation of the XR device and the wearable device using RF signals from the XR device and the wearable device such as by combining the RF signals. In such an example, the XR device can average the determined position and orientation of the XR device and the wearable device to estimate position and orientation of a user (or the XR device and wearable device used by the user).

In some aspects, the systems and techniques can include determining objects in the environment based on reflected RF signals from the objects. For example, the systems and techniques can include transmitting RF signals. In such an example, the RF signals can reflect off of objects in the environment. In an example where the RF signal is transmitted by an XR device, the XR device can received reflected RF signals from the object. The XR device can determine the object based on characteristics (e.g., features) of the reflected RF signals. For example, the XR device can transmit a plurality of RF signals at various angles to determine a shape of the objects. In some examples, the XR device can determine vibrations in the object based on shifts angles of reflected RF signals. In another example, the XR device can determine (e.g., identify) an object in the real-world environment based on moved of the object represented in the reflected RF signals. For example, the XR device can transmit RF signals which reflect off of an individual in the environment. In such an example, the XR device can detect gait of the individual (e.g., how the individual moves when he or she walks) to identify an individual in the real-world environment.

In some aspects, the systems and techniques can include using RF signals for location detection which can be used to communicate with various devices. For example, the RF signals transmitted by the XR device can be fifth generation (5G) or sixth generation (6G) of wireless cellular technology. In some examples, the RF signals can include messages (e.g., packets of data) which can be used to communicate with other devices. For example, the RF signals can be IEEE or 3GPP standards compatible RF signals. In some examples, the systems and techniques can include transmitting signals or orienting various sensors (e.g., image sensors, ranging sensors, etc.) at various angles from the XR device (or other device). For example, the XR device can use various ranging sensors, RF signals, and image sensors to detect objects in six degrees of freedom (6DoF). In such an example, the XR device can fuse information associated with the RF signals (e.g., spatial data indicating the locations of objects in the real-world environment from reflected RF signals) with images to identify objects.

In some aspects, the XR device can determine to adjust a local map or reference map when an object unrepresented in the local map or reference map is detected within a predetermined distance (e.g., within 20 feet) of the XR device. In some aspects, the XR device can activate cameras (e.g., cameras of the XR device) when the RF signals (e.g., RF signals transmitted by the XR device) indicate an object within the predetermined distance of the XR device. For example, the XR device can determine to activate cameras of the XR device when an object unrepresented in the local map or reference map is detected within the predetermined distance.

Various aspects of the present disclosure will be described with respect to the figures.

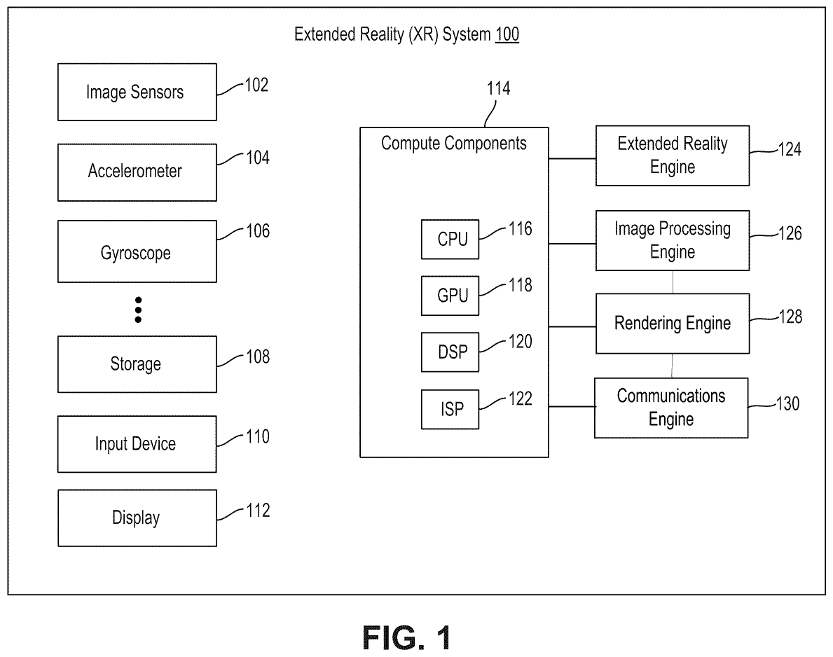

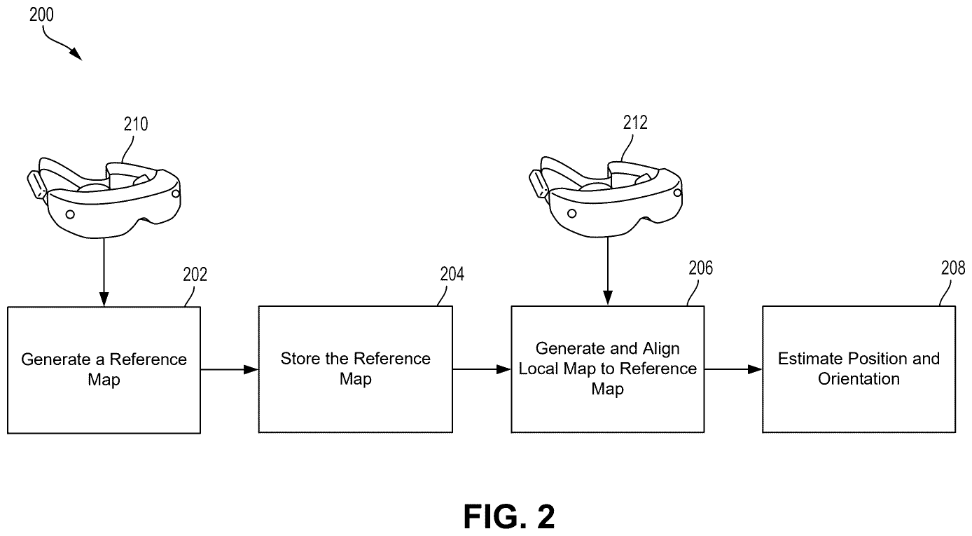

FIG. 1 is a diagram illustrating an architecture of an example extended reality (XR) system 100, in accordance with some aspects of the disclosure. XR system 100 may execute XR applications and implement XR operations. XR system 100 can include the HMD referenced in FIG. 2 and FIGS. 4-7. In some examples, the XR system can generate reference maps, such as the reference maps of block 202 of FIG. 2.

In this illustrative example, XR system 100 includes one or more image sensors 102, an accelerometer 104, a gyroscope 106, storage 108, an input device 110, a display 112, Compute components 114, an XR engine 126, an image processing engine 128, a rendering engine 130, and a communications engine 132. It should be noted that the components 102-132 shown in FIG. 1 are non-limiting examples provided for illustrative and explanation purposes, and other examples may include more, fewer, or different components than those shown in FIG. 1. For example, in some cases, XR system 100 can include one or more other sensors (e.g., one or more inertial measurement units (IMUs), light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 1. While various components of XR system 100, such as image sensor 102, may be referenced in the singular form herein, it should be understood that XR system 100 may include multiple of any component discussed herein (e.g., multiple image sensors 102).

Display 112 can be, or can include, a glass, a screen, a lens, a projector, and/or other display mechanism that allows a user to see the real-world environment and also allows virtual content to be overlaid, overlapped, blended with, or otherwise displayed thereon.

XR system 100 can include, or can be in communication with, (wired or wirelessly) an input device 110. Input device 110 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 102 can capture images that may be processed for interpreting gesture commands.

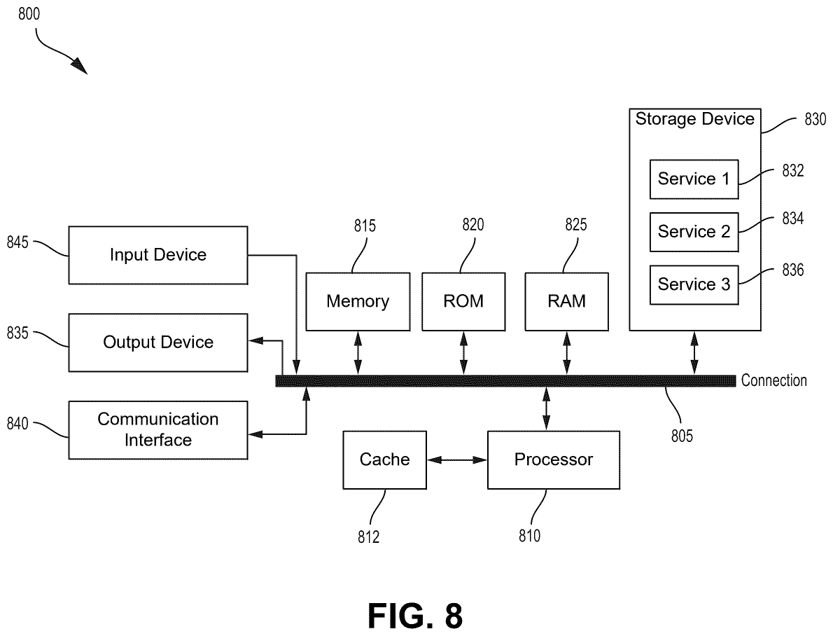

XR system 100 can also communicate with one or more other electronic devices (wired or wirelessly). For example, communications engine 132 can be configured to manage connections and communicate with one or more electronic devices. In some cases, communications engine 132 can correspond to communications interface 840 of FIG. 8.

In some implementations, image sensors 102, accelerometer 104, gyroscope 106, storage 108, display 112, compute components 114, XR engine 126, image processing engine 128, and rendering engine 130 can be part of the same computing device. For example, in some cases, image sensors 102, accelerometer 104, gyroscope 106, storage 108, display 112, compute components 114, XR engine 126, image processing engine 128, and rendering engine 130 may be integrated into an HMD, extended reality glasses, smartphone, laptop, tablet computer, gaming system, and/or any other computing device. However, in some implementations, image sensors 102, accelerometer 104, gyroscope 106, storage 108, display 112, compute components 114, XR engine 126, image processing engine 128, and rendering engine 130 may be part of two or more separate computing devices. For instance, in some cases, some of the components 102-132 may be part of, or implemented by, one computing device and the remaining components can be part of, or implemented by, one or more other computing devices. For example, such as in a split perception XR system, XR system 100 can include a first device (e.g., an HMD), including display 112, image sensor 102, accelerometer 104, gyroscope 106, and/or one or more compute components 114. XR system 100 may also include a second device including additional compute components 114 (e.g., implementing XR engine 126, image processing engine 128, rendering engine 130, and/or communications engine 132). In such an example, the second device may generate virtual content based on information or data (e.g., images, sensor data such as measurements from accelerometer 104 and gyroscope 106) and can provide the virtual content to the first device for display at the first device. The second device can be, or can include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 108 can be any storage device(s) for storing data. Moreover, storage 108 can store data from any of the components of XR system 100. For example, storage 108 may store data from image sensor 102 (e.g., image or video data), data from accelerometer 104 (e.g., measurements), data from gyroscope 106 (e.g., measurements), data from compute components 114 (e.g., processing parameters, preferences, virtual content, rendering content, scene maps, tracking and localization data, object detection data, privacy data, XR application data, face recognition data, occlusion data, etc.), data from XR engine 126, data from image processing engine 128, and/or data from rendering engine 130 (e.g., output frames). In some examples, storage 108 may include a buffer for storing frames for processing by compute components 114.

Compute components 114 can be or can include a central processing unit (CPU) 116, a graphics processing unit (GPU) 118, a digital signal processor (DSP) 120, an image signal processor (ISP) 122, a neural processing unit (NPU) 124, which may implement one or more trained neural networks, and/or other processors. Compute components 114 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 114 may implement (e.g., control, operate, etc.) XR engine 126, image processing engine 128, and rendering engine 130. In other examples, compute components 114 may also implement one or more other processing engines.

Image sensor 102 can include any image and/or video sensors or capturing devices. In some examples, image sensor 102 can be part of a multiple-camera assembly, such as a dual-camera assembly. Image sensor 102 can capture image and/or video content (e.g., raw image and/or video data), which can then be processed by compute components 114, XR engine 126, image processing engine 128, and/or rendering engine 130 as described herein.

In some examples, image sensor 102 can capture image data and can generate images (also referred to as frames) based on the image data and/or may provide the image data or frames to XR engine 126, image processing engine 128, and/or rendering engine 130 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 102 (and/or other camera of XR system 100) can be configured to also capture depth information. For example, in some implementations, image sensor 102 (and/or other camera) may include an RGB-depth (RGB-D) camera. In some cases, XR system 100 can include one or more depth sensors (not shown) that are separate from image sensor 102 (and/or other camera) and that may capture depth information. For instance, such a depth sensor may obtain depth information independently from image sensor 102. In some examples, a depth sensor may be physically installed in the same general location or position as image sensor 102 but may operate at a different frequency or frame rate from image sensor 102. In some examples, a depth sensor may take the form of a light source that may project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 100 can also include other sensors in its one or more sensors. The one or more sensors may include one or more accelerometers (e.g., accelerometer 104), one or more gyroscopes (e.g., gyroscope 106), and/or other sensors. The one or more sensors may provide velocity, orientation, and/or other position-related information to compute components 114. For example, accelerometer 104 may detect acceleration by XR system 100 and may generate acceleration measurements based on the detected acceleration. In some cases, accelerometer 104 may provide one or more translational vectors (e.g., up/down, left/right, forward/back) that may be used for determining a position or pose of XR system 100. Gyroscope 106 can detect and measure the orientation and angular velocity of XR system 100. For example, gyroscope 106 may be used to measure the pitch, roll, and yaw of XR system 100. In some cases, gyroscope 106 may provide one or more rotational vectors (e.g., pitch, yaw, roll). In some examples, image sensor 102 and/or XR engine 126 may use measurements obtained by accelerometer 104 (e.g., one or more translational vectors) and/or gyroscope 106 (e.g., one or more rotational vectors) to calculate the pose of XR system 100. As previously noted, in other examples, XR system 100 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of XR system 100, using a combination of one or more accelerometers, one or more gyroscopes, and/or one or more magnetometers. In some examples, the one or more sensors may output measured information associated with the capture of an image captured by image sensor 102 (and/or other camera of XR system 100) and/or depth information obtained using one or more depth sensors of XR system 100.

The output of one or more sensors (e.g., accelerometer 104, gyroscope 106, one or more IMUs, and/or other sensors) can be used by XR engine 126 to determine a pose of XR system 100 (also referred to as the head pose) and/or the pose of image sensor 102 (or other camera of XR system 100). In some cases, the pose of XR system 100 and the pose of image sensor 102 (or other camera) can be the same. The pose of image sensor 102 refers to the position and orientation of image sensor 102 relative to a frame of reference (e.g., field of view of the camera). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from image sensor 102 to track a pose (e.g., a 6DoF pose) of XR system 100. For example, the device tracker can fuse visual data (e.g., using a visual tracking solution) from the image data with inertial data from the measurements to determine a position and motion of XR system 100 relative to the physical world (e.g., the scene) and a map of the physical world. As described below, in some examples, when tracking the pose of XR system 100, the device tracker can generate a three-dimensional (3D) map of the scene (e.g., the real world) and/or generate updates for a 3D map of the scene. For example, the 3D map can be a mesh representation of the real-world. The 3D map updates can include, for example and without limitation, new or updated features and/or feature or landmark points associated with the scene and/or the 3D map of the scene, localization updates identifying or updating a position of XR system 100 within the scene and the 3D map of the scene, etc. The 3D map can provide a digital representation of a scene in the real/physical world (e.g., the 3D map can be a mesh representation the real/physical world). In some examples, the 3D map can anchor position-based objects and/or content to real-world coordinates and/or objects. XR system 100 can use a mapped scene (e.g., a scene in the physical world represented by, and/or associated with, a 3D map) to merge the physical and virtual worlds and/or merge virtual content or objects with the physical environment.

In some aspects, the pose of image sensor 102 and/or XR system 100 as a whole can be determined and/or tracked by compute components 114 using a visual tracking solution based on images captured by image sensor 102 (and/or other camera of XR system 100). For instance, in some examples, compute components 114 can perform tracking using computer vision-based tracking, model-based tracking, and/or simultaneous localization and mapping (SLAM) techniques. For instance, compute components 114 can perform SLAM or can be in communication (wired or wireless) with a SLAM system (not shown). SLAM refers to a class of techniques where a map of an environment (e.g., a map of an environment being modeled by XR system 100) is created while simultaneously tracking the pose of a camera (e.g., image sensor 102) and/or XR system 100 relative to that map. The map can be referred to as a SLAM map and can be three-dimensional (3D). The SLAM techniques can be performed using color or grayscale image data captured by image sensor 102, and/or other camera of XR system 100) and can be used to generate estimates of 6DoF pose measurements of image sensor 102 and/or XR system 100. Such a SLAM technique configured to perform 6DoF tracking can be referred to as 6DoF SLAM. In some cases, the output of the one or more sensors (e.g., accelerometer 104, gyroscope 106, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 102 (and/or other camera) to the SLAM map. For example, 6DoF SLAM can use feature point associations from an input image to determine the pose (position and orientation) of the image sensor 102 and/or XR system 100 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 102 and/or the XR system 100 can be determined by projecting features from the 3D SLAM map into an image or video frame and updating the camera pose from verified 2D-3D correspondences.

In one illustrative example, the compute components 114 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 114 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 100 can also track the hand and/or fingers of the user to allow the user to interact with and/or control virtual content in a virtual environment (e.g., an XR environment). For example, the XR system 100 can track a pose, gestures, and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 2 is a block diagram illustrating an example process 200 of aligning local maps and reference maps to determine position and orientation of an XR device (e.g., an XR HMD). The process 200 can be performed by an XR system or device, such as the XR system 100 of FIG. 1 or the XR device 210 and 212. In some examples, the XR device 210 and 212 can be the same XR device.

At block 202, the XR system, XR device, or component thereof (hereinafter referred to collectively as the XR device) can generate a reference map. The reference map can include a 3D spatial representation of a real-world environment in which the XR device operates. In some examples, the reference map can be a data structure indicating features (e.g., visual and physical characteristics of the environment such as the presence of objects and distances) of objects in the real-world environment. The XR device 210 can use various image processing techniques to generate the reference map.

For example, the XR device 210 can use techniques such as mesh generation using geometric estimations (e.g., polygons including vertices, edges, and faces of the polygons) of an environment to generate a 3D representation of the real-world environment. In another example, reference maps can be represented as voxels. In such an example, the XR device 210 can include scene-facing cameras and ranging sensors. For example, the XR device 210 can generate images including spatial data (e.g., ranging data from the ranging sensors) which can be represented as a voxel. In further examples, the XR device can generate a 3D point cloud representation of the environment based on detected distances of objects from the XR device 210 (e.g., using ranging sensors or the RF signals).

At block 204, the XR device can store reference maps. In some examples, the XR device 210 can store the reference map in local memory of the XR device 210. In further examples, the XR device 210 can store the reference map in a repository, database, server, etc. In some examples, the reference map can be associated with a location in which the reference map was generated (e.g., the real-world environment represented by the reference map). In such an example, the reference map can include metadata, a label, annotations, etc. indicating the location of the real-world environment represented by the reference map.

In some examples, the reference maps can be associated with an environment and used for multiple instances of rendering XR environments for locations in the environment. In such an example, an additional XR devices (e.g., XR device 212) can use the reference map generated by the XR device 210 when rendering an XR environment (e.g., a virtual environment). For example, the XR device 212 can query the repository, database, server, etc. storing reference maps to receive a reference map associated with the real-world environment in which the XR device 212 is operating. In some examples, the XR device 212 can download the reference map and store the reference map in local memory of the XR device 212.

At block 206, the XR device 212 can generate and align a local map to the reference map (e.g., the received or downloaded reference map). A local map (also referred to as a live map) can be a 3D representation of a real-world environment in which an XR device (e.g., the XR device 212) operates. For example, the local map can be a lower resolution 3D representation of the real-world environment than the reference map. In further examples, the local map can represent a smaller area (e.g., a portion) of the real-world environment represented in the reference map. The XR device 212 can generate the local map using various 3D modeling techniques such as mesh generation, voxel generation, 3D point cloud generation, etc. In another example, the XR device can use stereo vision techniques to generate a 3D representation of the real-world environment. In some examples, the XR device 212 can use RF signals to generate the local map. For example, the XR device 212 can transmit RF signals, and based on a round trip time (RTT) and angle of arrival (AoA) determine locations of objects within a real-world environment.

For example, the XR device 212 can use channel state information (CSI) of RF signals to determine features of the environment in which the XR device is located. For example, the CSI can include information such as attenuation, phase shifts, signal strength, fading, multipath effects (distortions in RF signals from scatterings), and doppler effects (e.g., changes in frequency of the RF signals during motion of a transmitter, receiver, or object).

At block 208, the XR device 212 can estimate position and orientation of the XR device and objects within the real-world environment. For example, the XR device 212 can determine, based on the alignment of the local map and the reference map, where the XR device 212 is positioned and oriented within the real-world environment. In some examples, the XR device 212 can use the position and orientation of the XR device 212 to render the XR environment to be viewed by the user.

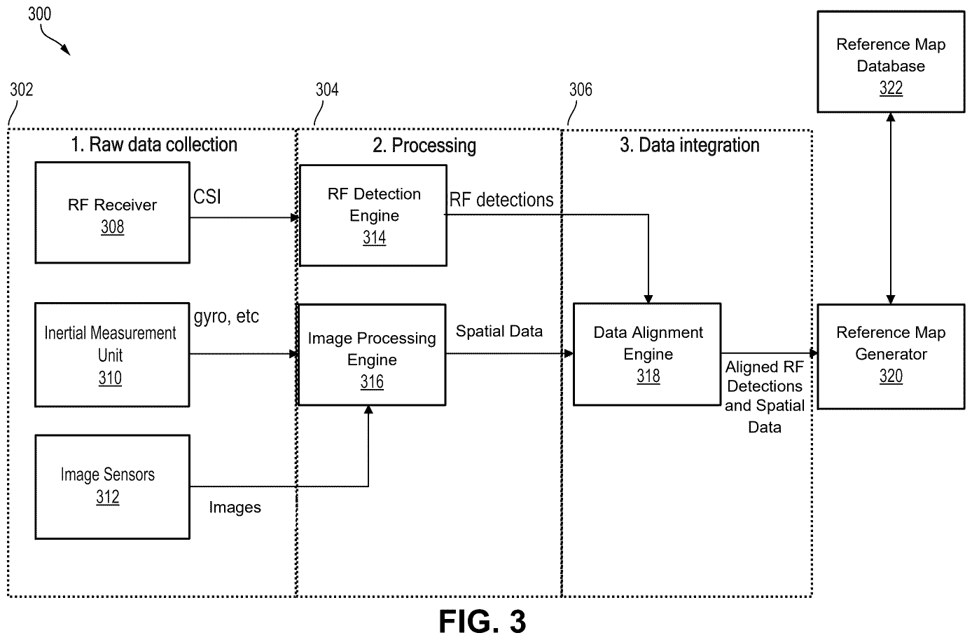

FIG. 3 is a block diagram illustrating an example of a data fusion pipeline 300 for map generation (e.g., reference map generation) using data collected from an XR device. The data fusion pipeline can include three phases. A first phase 302 associated with raw data collection, a second phase 304 associated with processing the collected raw data, and a third phase 306 associated with integrating processed raw data (e.g., performing data fusion). In some examples, the three phases can be performed using an XR device. In further examples, one or more phases can be performed on another computing device. In such an example, the first phase 302 can be performed using the XR device and the second phase 304 can be performed using another computing device.

The first phase 302 associated with raw data collection can include using an RF receiver 308, an inertial measurement unit (IMU) 310, and image sensors 312 to collect data associated with features of the environment and the orientation and position of the XR device (or the user). The RF receiver 308 can receive reflected RF signals (or RF signals transmitted from RF transmitting devices). The reflected RF signals can include CSI indicating features of the environment. For example, the CSI can include doppler effects, indicating the motion of an RF-transmitting device or an object in motion. In some examples, the RF receiver 308 can include a Wi-Fi receiver, cellular signal receiver (e.g., to receive UWB signals, 5G signals), etc.

The IMU 310 can generate orientation and motion data indicating the orientation and movement of an XR device (or other computing device) within a real-world environment. For example, the IMU 310 can include a gyroscope or accelerometer. In some examples, the XR device can be an HMD. In such an example, the orientation and motion data can indicate the orientation of the head of a user. In some examples, the XR device can determine where the field of view of the user from the orientation of the head of the user.

The image sensors 312 can generate image representing a real-world environment in which the XR device operates. The image sensors 312 can include scene-facing cameras of the XR device. In some examples, the XR device can include multiple image sensors 312. In such an example, the XR device can use stereo vision to determine depth from the generated images.

The second phase 304 can include processing the raw data collected in the first phase 302 to detect objects within the real-world environment and to determine features (e.g., characteristics) of the real-world environment represented in spatial data associated with the real-world environment. In some examples, the second phase 304 can be performed using the XR device used to collect raw data in the first phase 302.

For example, the second phase 304 can include using an RF detection engine 314 to process the CSI from the RF receiver 308 to detect objects in the real-world environment. For example, the CSI can indicate, based on doppler effects, an object in motion. In further examples, the CSI can include angle of arrival of RF signals indicating the position of RF transmitting devices in the environment. The RF detection engine 314 can output a message indicating RF detections determined from the CSI.

The second phase 304 can include using an image processing engine 316 to generate spatial data associated with the images generated by the image sensors 312 and orientation and movement data generated by the IMU 310. In some examples, the image processing engine 316 can use stereo vision techniques to determine depth of the real-world environment represented in the images. In some examples, the orientation and movement data of the IMU 310 can be processed with the images of the environment to determine where the XR device is located and oriented within the real-world environment. In some examples, the image processing engine 316 can generate depth maps representing the distances of characteristics of the real-world environment from the images. In further examples, the depth maps can include the orientation and movement data indicating orientation of the XR device when generating the images. In some examples, the spatial data can include values representing six degrees of freedom (6DoF). In such an example, the spatial data can be represented as values in a 3D coordinate system (e.g., x, y, and z planes) with additional values representing orientation within the 3D coordinate system (e.g., pitch, roll, and yaw). In further examples, the image processing engine 316 can compare estimates of XR device locations and orientation (e.g., location and orientation estimates determined based on angle of arrival of the RF signals, CSI, or other information from a received radio frequency (RF) signal) to additional sensors measuring orientation and position, such as the IMU 310, to determine offsets in the position and orientation. The offsets can be temporal and vary over time.

The third phase 306 can include performing data fusion to combine the RF detections and the spatial data. For example, the third phase 306 can include using a data alignment engine 318 to align the RF detections and the spatial data temporally and in location. In one example, the image sensors 312 and the RF receiver 308 can use different timestamps. In some examples, the data alignment engine 318 can perform data association to align data from the spatial data and the RF detections to determine whether the RF detections are represented in the spatial data. In further examples, the data alignment engine 318 can generate a data structure combining the spatial data and the RF detections. In some examples, the data alignment engine 318 can perform data cleaning of the spatial data and RF detections. For example, the data alignment engine 318 can remove duplicates of data and filter errors in the data. In some examples, the data fusion pipeline 300 can include upsampling, downsampling, and time alignment of data (e.g., between RF data and other sensor data such as images from image sensors). For example, the IMU 310 can generate position data at a first frequency (e.g., every 1 millisecond (ms)), image sensors generating images at a second frequency (e.g., 30 frames per second (fps)), and RF data can be received at a third frequency (e.g., every 100 ms). Upsampling or downsampling (i.e. dropping samples) can compensate for differences in frequencies of data generation or collection, for example by reducing sensor data generation of the IMU 310 to one every 100 ms. Aligning the three data types in time can provide information associated with position of objects from multiple sensor sources (IMU 310 data, images, RF data) corresponding to substantially the same time instant.

The data fusion pipeline 300 can include providing the aligned RF detections and spatial data to a reference map generator 320. The reference map generator 320 can use various 3D modeling techniques to generate a reference map from the aligned RF detections and spatial data. For example, the reference map generator 320 can generate a voxel, mesh, or 3D point cloud representation of the real-world environment from the aligned RF detections and spatial data.

The data fusion pipeline 300 can include storing the reference maps in a reference map database 322. For example, the reference map database 322 can include a plurality of reference maps associated with various real-world environments. XR devices can query the reference map database 322 to request reference maps associated with various real-world environments (e.g., the real-world environment in which the XR devices operate). In some examples, the reference maps can include metadata, annotations, or labels indicating real-world environments represented by the reference maps. In other examples, the query can include features of a local map generated by the XR device. In such an example, the reference map database 322 can provide reference maps to the XR device including features of the real-world environment represented in the query.

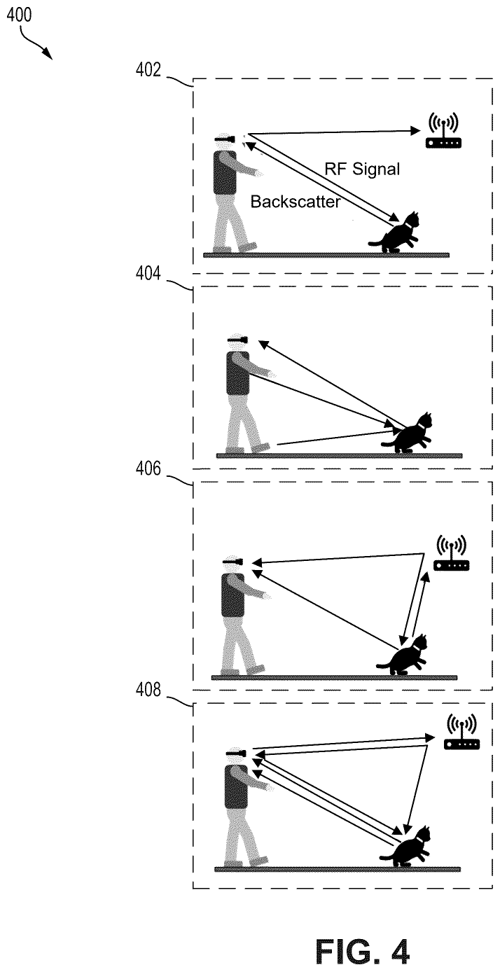

FIG. 4 is a block diagram 400 illustrating various RF sensing techniques using an XR device. For example, FIG. 4 illustrates monostatic sensing 402, bistatic sensing with wearable devices 404, bistatic sensing with RF transmitting devices 406, and hybrid monostatic/bistatic sensing 408.

Monostatic sensing 402 can be used to detect objects in an environment based on reflections of RF signals from a transmitter to a receiver. In some examples, the transmitter and the receiver can be co-located during monostatic sensing 402. For example, an XR device can include an RF transmitter and RF receiver. The XR device can transmit an RF signal (e.g., by the RF transmitter) and receive (e.g., by the RF receiver) a reflected RF signal. The reflected RF signal (e.g., a backscatter) can be the RF signal transmitted by the XR device reflected from an object in the environment. In some examples, the XR device can use RTT and AoA to determine positions of the objects reflecting the RF signals. In some examples, monostatic sensing 402 can be used to determine the location of objects or the XR device in an environment. For example, an RF transmitting device (such as an AP) can use monostatic sensing 402 to detect the location of a user using an XR device. In such an example, the RF transmitting device can transmit a message to the XR device indicating the XR device location.

Bistatic sensing with wearable devices 404 can include using multiple RF transmitting devices. For example, the RF transmitting devices can be wearable devices. In one such example, the wearable devices can include a haptic vest, haptic shoes, a smartwatch, and haptic gloves. The bistatic sensing with wearable devices 404 can include using RF signals output by the wearable devices to determine locations of objects or the location of the XR device within an environment. For example, the wearable devices can output an RF signal, and the XR device can receive reflected RF signals from objects in the environment. The XR device can determine, based on AoA and RTT of reflected RF signals, the location of the objects, the wearable devices, and the XR device.

Bistatic operation with RF transmitting devices 406 can be used to detect objects within an environment and to determine the location of the XR device in the environment. For example, an RF transmitting device can output RF signals and receive reflected RF signals from objects in the environment. The RF transmitting device can generate a message indicating the location of objects within the environment and transmit the message to the XR device. In some examples, the XR device can include an RF receiver to receive reflected RF signals and RF signals transmitted by the RF transmitting device.

Hybrid monostatic/bistatic sensing 408 can include receiving RF signals and transmitting RF signals to detect objects in the environment. For example, the XR device and an RF transmitting device can output RF signals. The XR device and the RF transmitting device can detect objects based on reflected RF signals and determine the location of objects based on the RTT and AoA of the reflected RF signals. The XR device and the RF transmitting device can transmit messages indicating objects detected by the respective devices.

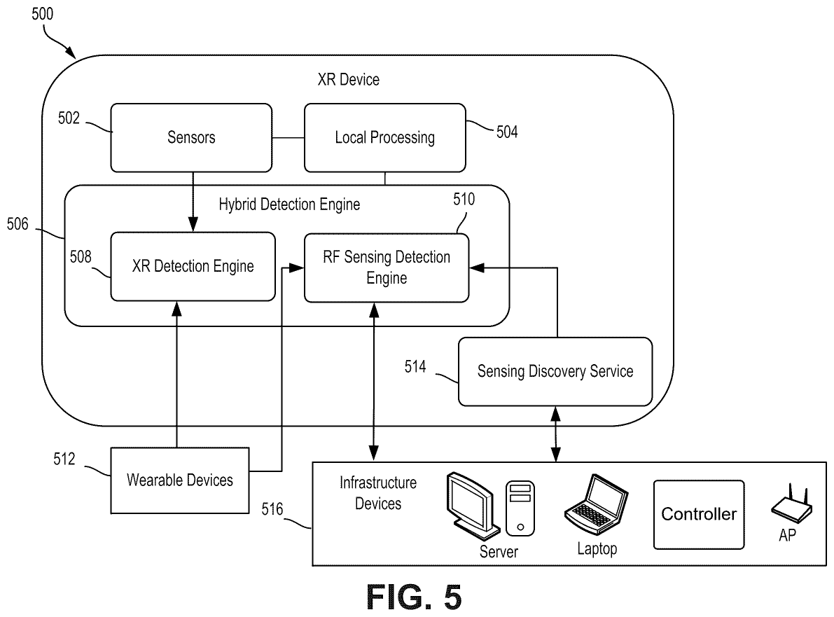

FIG. 5 is a block diagram illustrating an example XR device 500 using a hybrid detection engine 506 to detect objects (e.g., obstacles) in an environment based on RF signals and visual detection of the objects. The XR device 500 can include local processing 504 and various sensors 502, such as images sensors (e.g., scene-facing cameras), an IMU, etc. The local processing 504 can include various processors to generate 3D representations of a real-world environment to display to users based on sensor data generated by the sensors 502.

The hybrid detection engine 506 can receive sensor and RF signals to detect objects within a predetermined distance of the user. For example, the hybrid detection engine 506 can include an XR detection engine 508 to detect objects based on sensor data of the XR device 500 and an RF sensing detection engine 510 to detect objects based on RF signals. Including the XR detection engine 508 and the RF sensing detection engine 510 can provide the XR device 500 with object detection capabilities for objects not within a field of view the sensors 502. For example, the XR detection engine 508 can use image sensors to detect objects within a field of view of the image sensors. The RF sensing detection engine 510 can extend object detection capabilities of the XR device 500 to include areas of the environment not within the field of view of the sensors 502.

For example, the RF sensing detection engine 510 can detect objects within a predetermined distance based on reflected RF signals in an environment. For example, the RF sensing detection engine 510 can use CSI of reflected RF signals to determine location and movement of objects in an environment. For example, the RF sensing detection engine 510 can use RTT and AoA of reflected RF signals to determine whether an object is within a predetermined distance of the XR device 500. In some examples, the predetermined distance can be the range of an RF transmitter and RF receiver of the XR device. In another example, the predetermined distance can be a distance set by the XR device or a user at which to warn users of an object (e.g., an obstacle).

The XR device 500 can include sensing discovery service 514. The sensing discovery service 514 can detect infrastructure devices 516 within an environment which the XR device 500 can use to detect objects in the environment. For example, the sensing discovery services can set discovery criteria of the XR device 500 based on hardware capabilities of the XR device 500. Discovery criteria can include characteristics which the sensing discovery service 514 may use to determine whether various infrastructure devices 516 can be used for object detection using the RF sensing detection engine 510. For example, the discovery criteria can include battery power, hardware specifications (e.g., number and type of antennas), bandwidth, etc. of the XR device 500 or infrastructure devices 516. The sensing discovery service 514 can select infrastructure devices 516 to use to output RF signals for object detection using the RF sensing detection engine 510.

The XR device 500 can receive RF signals from various wearable device 512 and infrastructure devices 516. For example, the wearable devices 512 and the infrastructure devices 516 can be RF transmitting devices. In such an example, the wearable devices 512 or infrastructure devices 516 can output RF signals. The XR device 500 can receive the RF signals reflected from objects in the environment. In such an example, the XR device 500 can detect objects in the environment based on the FTT and AoA of the reflected RF signals. Infrastructure devices can include various RF transmitting devices such as a laptop, an access point, a server, a controller, etc. Wearable devices 512 can include various wearable electronics such as a haptic vest, haptic gloves, a smartwatch, haptic shoes, etc.

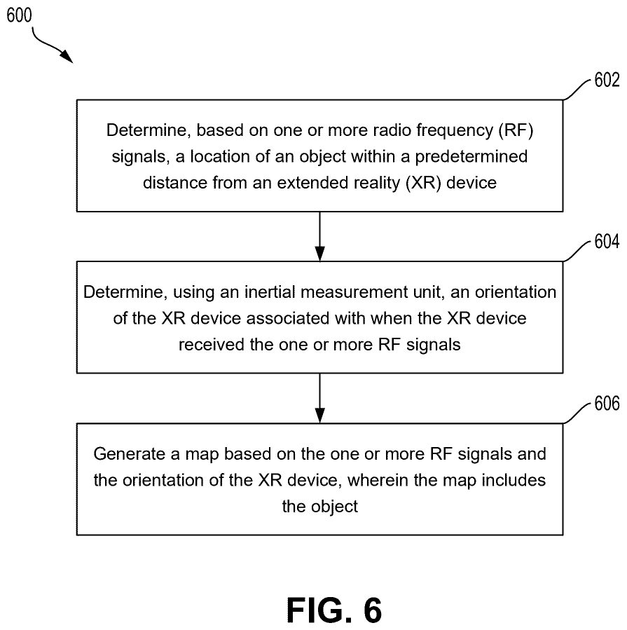

FIG. 6 is a block diagram illustrating an example process 600 for processing an RF signal to detect an object within proximity (e.g., a predetermined distance) of an XR device. In particular, the process 600 illustrates an example of detecting objects in motion in proximity of the XR device. The process 600 can be performed by a computing device (e.g., the XR system 100 of FIG. 1, the XR device 210 and 212 of FIG. 2, the XR device 500 of FIG. 5, the computing device or computing system 800 of FIG. 8, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., the processor 810 of FIG. 8, or other processor(s)) of the computing device. Further, the transmission and reception of signals by the computing device (or the XR device) in the process 600 can be enabled, for example, by one or more antennas and/or one or more transceivers (e.g., wireless transceiver(s)).

At block 602, the computing device (or component thereof) can determine, based on one or more RF signals, a location of an object within a predetermined distance from an XR device. For example, the RF signals can be associated with a packet of data (e.g., a signal packet). The data can include CSI indicating features of the environment. In some examples, the CSI can include doppler effects, such as CSI indicating the motion of an RF-transmitting device or an object in motion. The signal packet can include other examples of CSI such as information associated with attenuation, phase shifts, signal strength, fading, multipath effects (distortions in RF signals such as scattering), etc.

At block 604, the computing device (or component thereof) can determine, using an inertial measurement unit, an orientation of the XR device associated with when the XR device received the one or more RF signals.

At block 606, the computing device (or component thereof) can generate a map based on the one or more RF signals and the orientation of the XR device, wherein the map includes the object. In some examples, the object can be in motion (e.g., a moving object). In some examples, the computing device can process the signal packet and information associated with the orientation of the XR device to generate the map. For example, the computing device (or component thereof) can process the signal packet using a 2D Fourier Transform (FFT) to generate a 2D image representation of the distance of the XR device from the object and the relative speed (e.g., doppler speed) of the XR device to the object. In some examples, the map can represent as being the determined (determined from the 2D image representation) distance from the XR device. In further examples, the computing device can update the map based on the relative speed of the object and XR device, such as by updating the map when the distance between the object and the XR device changes.

In some examples, the computing device (or component thereof) can generate a reference map or receive the reference map from a database of reference maps. A reference map can be a predetermined representation of an environment in which a user (or the XR device) is located. For example, the reference map can be a 3D representation of an environment. When the user (or XR device) is positioned within the environment, the computing device (or component thereof) can access the reference map from a database of reference maps.

In some examples, the computing device (or component thereof) can, determine, based on the one or more RF signals, an additional object within the predetermined distance of the XR device is unrepresented in the reference map. In such an example, the computing device (or component thereof) can adjust the reference map based on the determination. For example, the computing device (or component thereof) can adjust the reference map to include the additional object. The computing device can store the adjusted reference map in a repository (or database) of reference maps. In such an example, the adjusted reference map can include metadata associated with a location represented by the adjusted reference map. In further examples, the computing device (or component thereof) can activate a camera (e.g., a camera of the XR device) based on a determination that the object is in motion within a predetermined distance of the XR device. In such an example, the computing device can generate an additional reference map associated with the location of the XR device using the one or more RF signals and the camera.

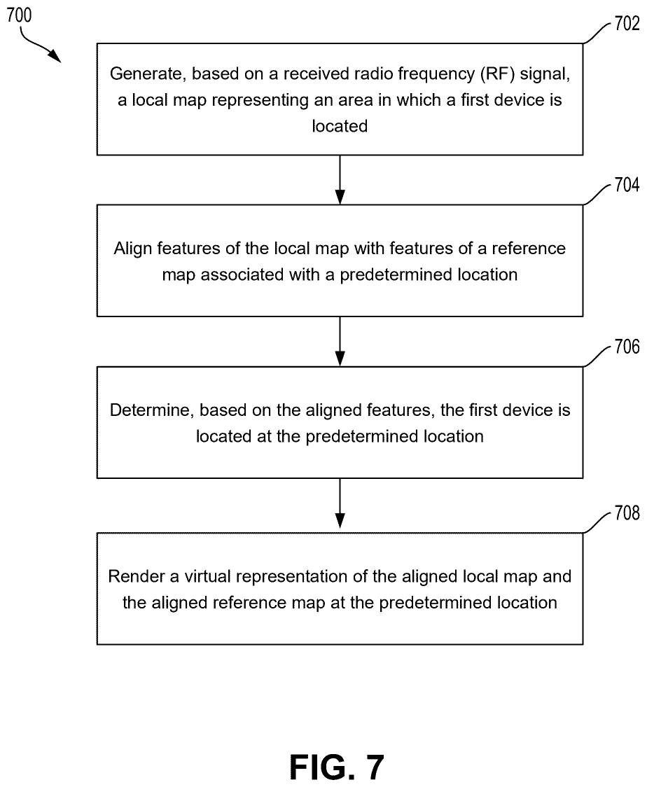

FIG. 7 is a flow diagram illustrating an example process 700 for rendering an XR environment. The process 700 can be performed by a computing device (e.g., the XR system 100 of FIG. 1, the XR device 210 and 212 of FIG. 2, the XR device 500 of FIG. 5, the computing device or computing system 800 of FIG. 8, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 700 can be implemented as software components that are executed and run on one or more processors (e.g., the processor 810 of FIG. 8, or other processor(s)) of the computing device. Further, the transmission and reception of signals by the computing device (or XR device) in the process 700 can be enabled, for example, by one or more antennas and/or one or more transceivers (e.g., wireless transceiver(s)).

At block 702, the computing device (or component thereof) can generate, based on a received radio frequency (RF) signal, a local map representing an area in which a first device is located. For example, the computing device (or component thereof) can be included in a first device, such as an XR device. In some examples, the XR device can include or can be an HMD. In further examples, the received RF signal can be from an access point (AP) such as a Wi-Fi access point. In further examples, the RF signal can be from another device located in the environment where the first device is located. For example, the RF signal can be from another XR device, from a range extending device (e.g., a repeater), etc.

In some examples, the received RF signal can be a reflected RF signal, such as a reflection of an RF signal transmitted by the first device. The reflected RF signal can be reflected off of an object in the environment. In further examples, the RF signal can include CSI associated with propagation characteristics of the received RF signal. For example, the CSI can include doppler speed of an object, attenuation, phase shifts, signal strength, fading, multipath effects (distortions in RF signals such as scattering), etc. In such an example, the local map can be generated based on the CSI.

In further examples, the computing device (or component thereof) can use monostatic or bistatic sensing of RF signals (e.g., the received RF signal). For example, the computing device (or component thereof) can receive a second RF signal (e.g., a second received RF signal). In such an example, the received RF signal can be used to triangulate a location of the first device (e.g., of the computing device when the computing device is part of or is the first device). In further examples, the generation of the local map can be based on the received RF signal including an angle of arrival (AoA) of the received RF signal and a round trip time (RTT) associated with an amount of time to receive the received RF signal from when the received RF signal was transmitted.

In further examples, the RF signals can be transmitted from a wearable device of the user. For example, the wearable device is at least one of a haptic vest, haptic gloves, a smartwatch, or haptic shoes. The first device can receive the RF signals from the wearable device and reflected RF signals from the wearable device to triangulate the position of the first device in the environment. In further examples, the generation of the local map can be based on a reflection of the received RF signal and images generated using one or more cameras of the first device. For example, the first device (e.g., the XR device or computing device) can include one or more cameras. In such an example, the local map can be generated based on fusion data of the RF signal and images generated using the one or more cameras.

At block 704, the computing device (or component thereof) can align features of the local map with features of a reference map associated with a predetermined location. For example, the computing device (or component thereof) can compare features of the local map with features of the reference map to align the maps.

At block 706, the computing device (or component thereof) can determine, based on the aligned features, the first device is located at the predetermined location. For example, the computing device (or component thereof) can determine the location of the first device based on the features of the reference map and the local map aligning. When the features substantially align, the computing device can determine the location of the first device based on the alignment.

At block 708, the computing device (or component thereof) can render a virtual representation of the aligned local map and the aligned reference map at the predetermined location. For example, the virtual representation can be a 3D model representation. In some examples, the computing device (or component thereof) can determine, based on a second received RF signal, an object in motion within a predetermined distance of the first device. For example, the computing device (or component thereof) can identify objects as being in motion based on the received RF signals, such as based on the CSI of the received RF signals. For example, the CSI can include doppler speed of the object. In other examples, the computing device (or component thereof) can determine the object to be in motion based on RF signals indicating the object to be at a first position at a first time period and at a second position at a second time period. The computing device (or component thereof) can activate a camera of the first device based on the determination (e.g., based on determining the object is in motion within a predetermined distance of the first device). In such an example, the computing device (or component thereof) can generate an additional reference map associated with the location of the first device using the second received RF signal and the activated camera.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for rendering an extended reality (XR) environment, the apparatus comprising: at least one memory; and at least one processor coupled to the at least one memory and configured to: generate, based on a received radio frequency (RF) signal, a local map representing an area in which a first device is located; align features of the local map with features of a reference map associated with a predetermined location; determine, based on the aligned features, the first device is located at the predetermined location; and render a virtual representation of the aligned local map and the aligned reference map at the predetermined location.

Aspect 2. The apparatus of Aspect 1, wherein the local map is generated based on channel state information (CSI) associated with propagation characteristics of the received RF signal.

Aspect 3. The apparatus of any of Aspects 1 to 2, wherein the received RF signal is a reflection of an RF signal transmitted by the first device.

Aspect 4. The apparatus of any of Aspects 1 to 3, wherein the generation of the local map associated with the first device is based on the received RF signal and a second received RF signal used to triangulate a location of the first device.

Aspect 5. The apparatus of any of Aspects 1 to 4, wherein the generation of the local map is based on the received RF signal including an angle of arrival (AoA) of the received RF signal and a round trip time (RTT) associated with an amount of time to receive the received RF signal from when the received RF signal was transmitted.

Aspect 6. The apparatus of any of Aspects 1 to 5, wherein the second received RF signal was transmitted by a wearable device.

Aspect 7. The apparatus of any of Aspects 1 to 6, wherein the wearable device is at least one of a haptic vest, haptic gloves, a smartwatch, or haptic shoes.

Aspect 8. The apparatus of any of Aspects 1 to 7, wherein the generation of the local map is based on a reflection of the received RF signal and images generated using one or more cameras of the first device.

Aspect 9. The apparatus of any of Aspects 1 to 8, wherein the first device is an extended reality (XR) head mounted device (HMD), and wherein the received RF signal is provided by a Wi-Fi access point.

Aspect 10. The apparatus of any of Aspects 1 to 9, wherein the at least one processor is further configured to: determine, based on a second received RF signal, an object in motion within a predetermined distance of the first device; activate a camera of the first device based on the determination; and generate an additional reference map associated with the location of the first device using the second received RF signal and the activated camera.

Aspect 11. An apparatus for rendering an extended reality (XR) environment, the apparatus comprising: at least one memory; and at least one processor coupled to the at least one memory and configured to: determine, based on one or more radio frequency (RF) signals, a location of an object within a predetermined distance from an extended reality (XR) device; determine, using an inertial measurement unit, an orientation of the XR device associated with when the XR device received the one or more RF signals; and generate a map based on the one or more RF signals and the orientation of the XR device, wherein the map includes the object.

Aspect 12. The apparatus of Aspect 11, wherein the at least one processor is further configured to: generate a reference map or receive the reference map from a database of reference maps, wherein each reference map is associated with the predetermined location of one or more objects.

Aspect 13. The apparatus of any of Aspects 11 to 12, wherein the at least one processor is further configured to: determine, based on the one or more RF signals, an additional object within the predetermined distance of the XR device unrepresented in the reference map; and adjust the reference map based on the determination.

Aspect 14. The apparatus of any of Aspects 11 to 13, wherein the at least one processor is further configured to: store the adjusted reference map in a repository of reference maps, wherein the adjusted reference map includes metadata associated with a location represented by the adjusted reference map.

Aspect 15. The apparatus of any of Aspects 11 to 14, wherein the at least one processor is further configured to: determine, based on the one or more RF signals, the object in motion within the predetermined distance of the XR device; activate a camera of the XR device based on the determination; and generate an additional reference map associated with the location of the XR device using the one or more RF signals and the camera.

Aspect 16. A method for rendering an extended reality (XR) environment, the method comprising: generating, based on a received radio frequency (RF) signal, a local map representing an area in which a first device is located; aligning features of the local map with features of a reference map associated with a predetermined location; determining, based on the aligned features, the first device is located at the predetermined location; and rendering a virtual representation of the aligned local map and the aligned reference map at the predetermined location.

Aspect 17. The method of Aspect 16, wherein the local map is generated based on channel state information (CSI) associated with propagation characteristics of the received RF signal.

Aspect 18. The method of any of Aspects 16 to 17, wherein the received RF signal is a reflection of an RF signal transmitted by the first device.

Aspect 19. The method of any of Aspects 16 to 18, wherein the generation of the local map associated with the first device is based on the received RF signal and a second received RF signal used to triangulate a location of the first device.

Aspect 20. The method of any of Aspects 16 to 19, wherein the generation of the local map is based on the received RF signal including an angle of arrival (AoA) of the received RF signal and a round trip time (RTT) associated with an amount of time to receive the received RF signal from when the received RF signal was transmitted.

Aspect 21. The method of any of Aspects 16 to 20, wherein the second received RF signal was transmitted by a wearable device.

Aspect 22. The method of any of Aspects 16 to 21, wherein the wearable device is at least one of a haptic vest, haptic gloves, a smartwatch, or haptic shoes.

Aspect 23. The method of any of Aspects 16 to 22, wherein the generation of the local map is based on a reflection of the received RF signal and images generated using one or more cameras of the first device.

Aspect 24. The method of any of Aspects 16 to 23, wherein the first device is an extended reality (XR) head mounted device (HMD), and wherein the received RF signal is provided by a Wi-Fi access point.

Aspect 25. The method of any of Aspects 16 to 24, further comprising: determining, based on a second received RF signal, an object in motion within a predetermined distance of the first device; activating a camera of the first device based on the determination; and generating an additional reference map associated with the location of the first device using the second received RF signal and the activated camera.

Aspect 26. A method for rendering an extended reality (XR) environment, the method comprising: determining, based on one or more radio frequency (RF) signals, a location of an object within a predetermined distance from an extended reality (XR) device; determining, using an inertial measurement unit, an orientation of the XR device associated with when the XR device received the one or more RF signals; and generating a map based on the one or more RF signals and the orientation of the XR device, wherein the map includes the object.

Aspect 27. The method of Aspect 26, further comprising: generating a reference map or receive the reference map from a database of reference maps, wherein each reference map is associated with the predetermined location of one or more objects.

Aspect 28. The method of any of Aspects 26 to 27, further comprising: determining, based on the one or more RF signals, an additional object within the predetermined distance of the XR device unrepresented in the reference map; and adjusting the reference map based on the determination.

Aspect 29. The method of any of Aspects 26 to 28, further comprising: storing the adjusted reference map in a repository of reference maps, wherein the adjusted reference map includes metadata associated with a location represented by the adjusted reference map.

Aspect 30. The method of any of Aspects 26 to 29, further comprising: determining, based on the one or more RF signals, the object in motion within the predetermined distance of the XR device; activating a camera of the XR device based on the determination; and generating an additional reference map associated with the location of the XR device using the one or more RF signals and the camera.

Aspect 31. A non-transitory computer-readable medium having stored thereon instructions that, when executed by at least one processor, cause the at least one processor to perform one or more of operations according to any of Aspects 16 to 30.

Aspect 32. An apparatus for, the apparatus for rendering an extended reality (XR) environment comprising one or more means for performing operations according to any of Aspects 16 to 30.

What is claimed is:

1. An apparatus for rendering an extended reality (XR) environment, the apparatus comprising:
at least one memory; and
at least one processor coupled to the at least one memory and configured to:
generate, based on a received radio frequency (RF) signal, a local map representing an area in which a first device is located;
align features of the local map with features of a reference map associated with a predetermined location;
determine, based on the aligned features, the first device is located at the predetermined location; and
render a virtual representation of the aligned local map and the aligned reference map at the predetermined location.

2. The apparatus of claim 1, wherein the local map is generated based on channel state information (CSI) associated with propagation characteristics of the received RF signal.

3. The apparatus of claim 1, wherein the received RF signal is a reflection of an RF signal transmitted by the first device.

4. The apparatus of claim 1, wherein the generation of the local map associated with the first device is based on the received RF signal and a second received RF signal used to triangulate a location of the first device.

5. The apparatus of claim 4, wherein the generation of the local map is based on the received RF signal including an angle of arrival (AoA) of the received RF signal and a round trip time (RTT) associated with an amount of time to receive the received RF signal from when the received RF signal was transmitted.

6. The apparatus of claim 4, wherein the second received RF signal was transmitted by a wearable device.

7. The apparatus of claim 6, wherein the wearable device is at least one of a haptic vest, haptic gloves, a smartwatch, or haptic shoes.

8. The apparatus of claim 1, wherein the generation of the local map is based on a reflection of the received RF signal and images generated using one or more cameras of the first device.

9. The apparatus of claim 1, wherein the first device is an extended reality (XR) head mounted device (HMD), and wherein the received RF signal is provided by a Wi-Fi access point.

10. The apparatus of claim 1, wherein the at least one processor is further configured to:
determine, based on a second received RF signal, an object in motion within a predetermined distance of the first device;
activate a camera of the first device based on the determination; and
generate an additional reference map associated with the location of the first device using the second received RF signal and the activated camera.

11. An apparatus for rendering an extended reality (XR) environment, the apparatus comprising:
at least one memory; and
at least one processor coupled to the at least one memory and configured to:
determine, based on one or more radio frequency (RF) signals, a location of an object within a predetermined distance from an extended reality (XR) device;
determine, using an inertial measurement unit, an orientation of the XR device associated with when the XR device received the one or more RF signals; and
generate a map based on the one or more RF signals and the orientation of the XR device, wherein the map includes the object.

12. The apparatus of claim 11, wherein the at least one processor is further configured to:
generate a reference map or receive the reference map from a database of reference maps, wherein each reference map is associated with the predetermined location of one or more objects.

13. The apparatus of claim 12, wherein the at least one processor is further configured to:
determine, based on the one or more RF signals, an additional object within the predetermined distance of the XR device unrepresented in the reference map; and
adjust the reference map based on the determination.

14. The apparatus of claim 13, wherein the at least one processor is further configured to:
store the adjusted reference map in a repository of reference maps, wherein the adjusted reference map includes metadata associated with a location represented by the adjusted reference map.

15. The apparatus of claim 11, wherein the at least one processor is further configured to:
determine, based on the one or more RF signals, the object in motion within the predetermined distance of the XR device;
activate a camera of the XR device based on the determination; and
generate an additional reference map associated with the location of the XR device using the one or more RF signals and the camera.

16. A method for rendering an extended reality (XR) environment, the method comprising:
generating, based on a received radio frequency (RF) signal, a local map representing an area in which a first device is located;
aligning features of the local map with features of a reference map associated with a predetermined location;
determining, based on the aligned features, the first device is located at the predetermined location; and
rendering a virtual representation of the aligned local map and the aligned reference map at the predetermined location.

17. The method of claim 16, wherein the local map is generated based on channel state information (CSI) associated with propagation characteristics of the received RF signal.

18. The method of claim 16, wherein the received RF signal is a reflection of an RF signal transmitted by the first device.

19. The method of claim 16, wherein the generation of the local map associated with the first device is based on the received RF signal and a second received RF signal used to triangulate a location of the first device.

20. The method of claim 19, wherein the generation of the local map is based on the received RF signal including an angle of arrival (AoA) of the received RF signal and a round trip time (RTT) associated with an amount of time to receive the received RF signal from when the received RF signal was transmitted.
